(19) United States
(12) Patent Application Publication
(10) Pub. No.: US 2012/0299285 A1
(43) Pub. Date: Nov. 29, 2012

(54) Medical Care Planner

(76) Inventor: Erin Bruneau, Kissimmee, FL (US)

(21) Appl. No.: 13/115,188

(22) Filed: May 25, 2011

(51) Int. Cl. B42D 1/00

(52) U.S. Cl. 281/15.1

(57) ABSTRACT

A medical care planner and method for managing, categorizing, and displaying an individual's entire medical and personal information status in an easy to create and easy to read format. The planner guides patients and caregivers as they confront, and endeavor to overcome, a serious diagnosis or health crisis. The planner facilitates the reduction of the overwhelming psychological nature of the diagnosis event by compartmentalizing it into manageable phases and enabling a patient or caregiver to overcome and quickly envision their first step toward treatment and managed care. The planner may be a lifesaving article in emergency situations by providing emergency personnel with required information. The planner may also be used both during doctor visits and hospital stays to eliminate mistakes and on a daily basis to manage the individual's taking of medications. The planner may be carried by the patient and/or be freely accessible to medical professionals as needed.

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention relates to article and method for managing a person's medical and personal emergency information, more particularly, the present invention enables patients, medical professionals, caregivers, family members or supporters and individuals to establish an undated centralized record of patient information including emergency contact information, medical information, dental treatment chart, insurance information, dietary information, medication information, expense information, and the like to be utilized when the medical need arises for the patient to ensure efficient and accurate patient care data as well as a reference point to keep all caregivers up to the minute with any treatment and or medication and care the patient is receiving.

2. Background Art

It is often necessary to provide a patient, a doctor, or a care provider with information relative to the patient's health condition and any prior or existing treatment relative to such a condition. This information needs to be readily accessible, comprehensive, accurate, and as complete as possible. It should include such facts as the patient's name, address, telephone number, names and telephone numbers of prior or personal physicians, as well as emergency telephone numbers, medical insurance numbers and any information related to pre-existing conditions for which the patient has been treated. Also, it should include prior diagnosis, medicines prescribed and currently being used by the patient, diets prescribed for the patient, medical history and current hospital data. Any allergies which the patient might have should be revealed, and detailed instructions previously given to the patient with reference to his condition as well as prescribed treatments, should be made known.

Relying on memory to supply this information is risky and, in some instances, results either in failure to supply correct information or omission of pertinent information that would be of assistance to a treating physician. Such errors or omissions could be of vital importance to a patient's treatment.

A patient may frequently undergo events such as a job related move, either temporary or permanent, from a location or a change in an employer's healthcare coverage providers in which the patient was being treated by a previous physician and the necessity arises of providing any new physician with all pertinent information concerning the patient, his maladies or sicknesses and the current treatment that had been provided by the previous physician.

In more serious situations, the patient may not personally be in a condition to pass their vital treatment information on to a new treating physician. Additionally, older patients frequently are unclear as to their medications, and the medical care planner of the present invention assists them in supplying the right information, and aids medical personnel in providing proper care to such patients.

The present invention teaches a patient medical care planner that preferably is in easily conveyable form so the patient can carry it on his person. The planner may provide the most complete information concerning the patient to either a succeeding physician, a caregiver, or to a person or persons confronted with an occurrence or accident that prevents the patient from transmitting the information themselves.

It is also a well-known fact that an attempt to carry all of this significant information in one's memory for transferring to another person presents a serious risk of overlooking some factors or information that otherwise could be of substantial help to treating persons under all circumstances which might be present.

It is accordingly an important aspect of the present invention to overcome such aforementioned difficulties so that a patient may be more quickly treated by one to whom the previous information is available and in some circumstances this information, as transmitted, might even be used in saving a patient's life by eliminating time-consuming diagnosis and/or other factors which might affect treatment of the patient. Likewise, one or more caregivers may utilize the present invention to stay up to date on a patient's treatment, medicinal dosages, expenses, milestones, and the like to make sure that no event is either missed or duplicated.

While the present invention will be specifically described in a single preferred form of construction, obviously the invention is not limited to this specific structure and variations in specifics of details of construction will be obvious and within the scope of the invention as defined by the claims herein.

### BRIEF SUMMARY OF THE INVENTION

The present invention comprises an article and/or method that have one or more of the following features and/or steps, which alone or in any combination may comprise patentable subject matter.

In accordance with one embodiment of the present invention, a medical care planner for organizing and recording patient information comprising a cover having a front portion and a back portion, a plurality of pages disposed between the front portion and the back portion of the cover, and a binding in communication with the cover and the plurality of pages for maintaining the medical care planner in a bound configuration.

Additional embodiments of the present invention may further comprise at least one pocket folder and/or at least one envelope capable of holding a plurality of loose items. The plurality of pages may also comprise one or more of the following sections either alone or in combination including but not limited to a business card section, a quick reference section, an insurance contact section, a common contact section, a personal contact section, a dental treatment section, a milestone information section, an undated calendar section, a daily meal record section, a patient care notes section, a medication log section, a medication information section, and a travel and expense record section.

Each day, regular people learn that their life is about to change because of a health related diagnosis or other challenge. While there are a number of support groups and information available regarding many of these specific challenges, this invention presents all the necessary information, is easy to use, and works for any level health crisis such as critical injury, chronic, catastrophic or terminal illness diagnosis that may arise.

The article and method of the present invention helps to transition a person from diagnosis to managed care in an organized fashion that allows users to keep track of important information including but not limited to emergency contact information, medical information, insurance information, medication dosage information, and their equally important personal progress and milestones attained during their challenge.

The present invention is especially helpful for healthcare professionals, caregivers, friends and family, and other supporters because they can learn and understand a patient's goals and mindset without guesswork.

By breaking up the medical care experience into phases (e.g. monthly), treatment doesn't seem so overwhelming. The phases also allow patients to mark their progress and milestones achieved as they continue with their treatments.

This invention comprises an article and method that guide patients, caregivers or supporters, and individuals as they confront and endeavor to overcome a serious health crisis or major life transition. The medical care planner reduces the overwhelming negative psychological nature of the diagnosis event by compartmentalizing it into manageable phases (based on distance from diagnosis) and thereby enables a patient and/or caregiver to overcome and quickly envision their “first step” toward wellbeing or managed care. The present invention comprises a medical care planner that serves as an organizer, patient/caregiver note and record keeper, medical communication tool, and a progressive documentation of the patient and caregiver's story.

In the area of health care in which the number of patients typically outnumbers the number of doctors, there is a growing need for personal management of a person's medical history and present medical status in order to avoid confusion and mistakes by health care personnel. For example, in an emergency situation in which a patient is under stress or impaired, it is desirable that the patient has a printed record that may be carried on their person or otherwise be easily accessible for conveying critical information that can be read by emergency personnel. Also, it is desirable for the patient or caregiver to include medication dosages and other information that can be read by the emergency personnel or other caregivers.

This invention encompasses a thoroughly integrated article and method that addresses all of the above problems in a single solution.

The system has the advantages of managing, categorizing, and displaying an individual's entire medical and personal status in an easy to record and easy to read format. The medical care planner may be used as a life saving device in an emergency situation to provide emergency personnel with required information. The planner may also be used both during doctor visits and hospital stays to eliminate mistakes and on a daily basis to manage the individual's taking of medications. Since the medical care planner is recorded and created by the patient and/or caregiver, there is no limit to the amount of reports available or the amount of updates or revisions that are possible. The planner may be carried on the patient and/or be freely accessible to all necessary medical personnel and family members. The additional benefits of the present invention will be more fully described in the detailed description provided below and by reference to the following drawings.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a front perspective view of a medical care planner of the present invention.

FIG. 2 depicts another front perspective view of a medical care planner of the present invention.

FIG. 3 depicts still another front perspective view of a medical care planner of the present invention.

FIG. 4 depicts an exemplary embodiment of a contents page of a medical care planner of the present invention.

FIG. 5 depicts an exemplary embodiment of a business card section of a medical care planner of the present invention.

FIG. 6 depicts an exemplary embodiment of a quick reference section of a medical care planner of the present invention.

FIG. 7 depicts an exemplary embodiment of an insurance contact section of a medical care planner of the present invention.

FIG. 8 depicts an exemplary embodiment of a common contact section of a medical care planner of the present invention.

FIG. 9 depicts an exemplary embodiment of a personal contact section of a medical care planner of the present invention.

FIG. 10 depicts an exemplary embodiment of a dental treatment section of a medical care planner of the present invention.

FIG. 11 depicts an exemplary embodiment of a milestones information section of a medical care planner of the present invention.

FIG. 12 depicts an exemplary embodiment of an undated calendar section of a medical care planner of the present invention.

FIG. 13 depicts an exemplary embodiment of an additional undated calendar section of a medical care planner of the present invention.

FIG. 14 depicts an exemplary embodiment of a daily meal record section of a medical care planner of the present invention.

FIG. 15 depicts an exemplary embodiment of a patient care notes section of a medical care planner of the present invention.

FIG. 16 depicts an exemplary embodiment of a medicinal log section of a medical care planner of the present invention.

FIG. 17 depicts an exemplary embodiment of an additional medicinal log section of a medical care planner of the present invention.

FIG. 18 depicts an exemplary embodiment of a medication information section of a medical care planner of the present invention.

FIG. 19 depicts an exemplary embodiment of a travel and expense record section of a medical care planner of the present invention.

FIG. 20 depicts an exemplary embodiment of an additional travel and expense record section of a medical care planner of the present invention.

### DETAILED DESCRIPTION OF THE INVENTION

The following documentation provides a detailed description of the invention.

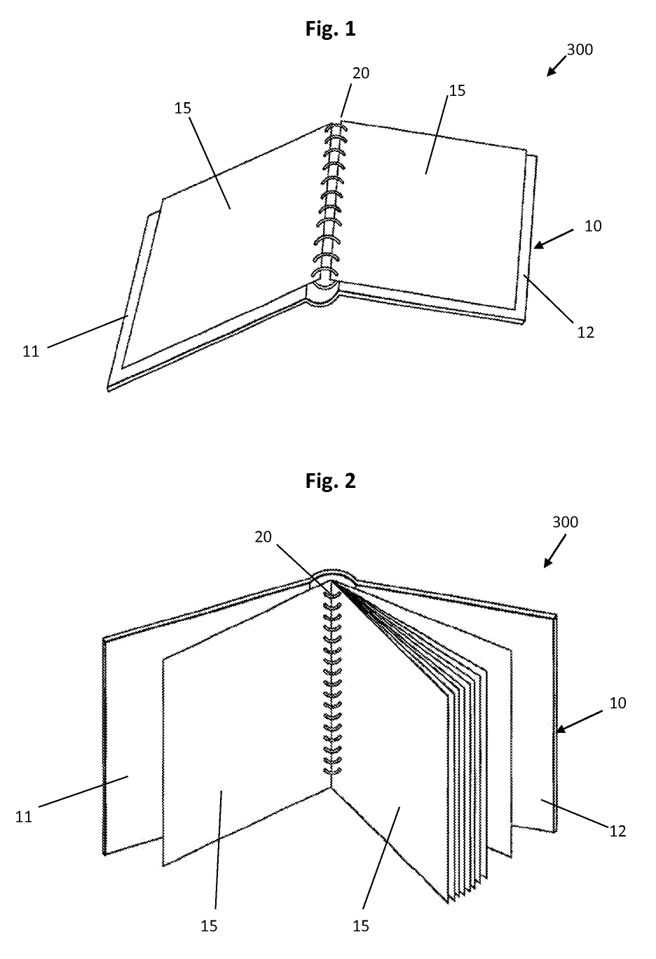

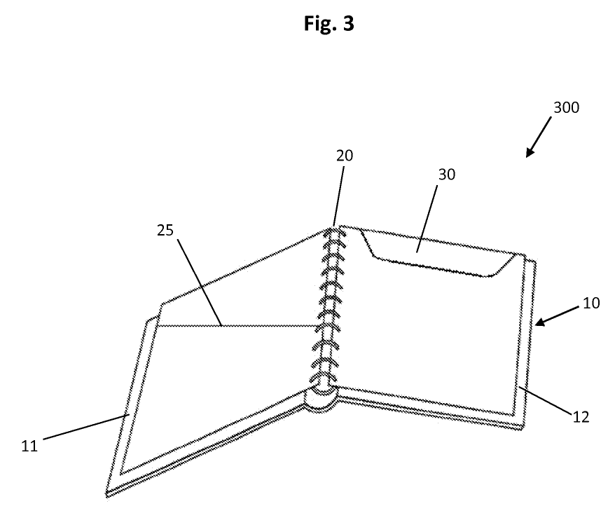

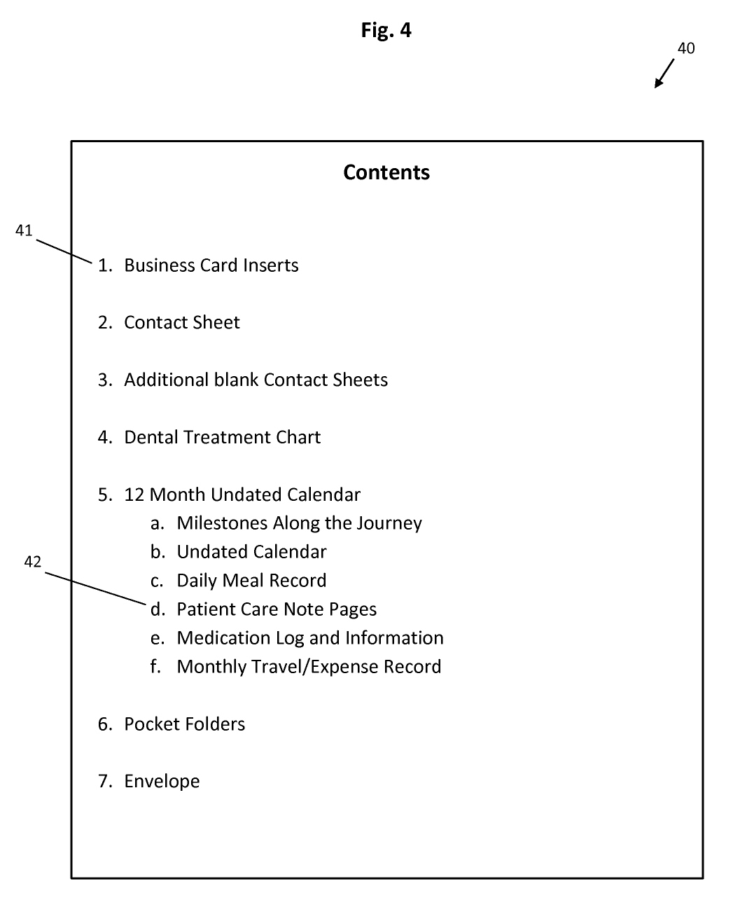

FIGS. 1-3 represent the general physical structure of one embodiment of a medical care planner 300 of the present invention. The medical care planner 300 may comprise a cover 10 having a front portion 11 and a back portion 12, wherein a plurality of pages 15 may be held between the front 11 and back portion 12 of the cover 10 by a binding 20 in a bound configuration. Additionally, the medical care planner 300 may further comprise at least one pocket folder 25 and/or at least one envelope 30, wherein each structure may be capable of holding a plurality of loose items that may include but is not limited to papers, receipts, notes cards, brochures, pamphlets, CDs, DVDs, and the like. The disclosure provided below further describes details of the medical care planner 300 of the present invention and its functionality.

The cover 10 and binding 20 may comprise any structural configurations known within the art and such configurations are not critical to the functionality of the medical care planner 300 of the present invention. As an example, the cover 10 may comprise but is not limited to paper, laminated material, paper stock, hard covers, and the like. Likewise, the manner of forming the binding 20 may include but is not limited to spiral binding, comb binding, permanent ring binding, releasable ring binding (e.g. three-ring binders), velo binding, tape binding, wire-o binding, perfect binding, case binding, coil binding, saddle-stitch binding, side-stitch binding, and the like.

FIG. 4 illustrates an exemplary embodiment of a contents section 40 that may assist a user in navigating through the medical care planner 300 of the present invention. The contents section 40 may comprise one or more section headings 41 to describe the high level sections within the planner 300 while a plurality of sub-section headings 42 may describe more specific portions of the medical care planner 300. The content section 40 may provide a general overview of the planner 300 for first time users and/or serve as a quick-navigation tool for even the most experienced users. The one or more section headings 41 and/or the plurality of sub-section headings 42 may have corresponding tabs or other distinguishing features placed throughout the medical care planner 300 at the physical location of the respective one or more section headings 41 and/or the plurality of sub-section headings 42 to allow the user to quickly reference the contents section 40 and then find the appropriate physical location of the section 41 or sub-section 42.

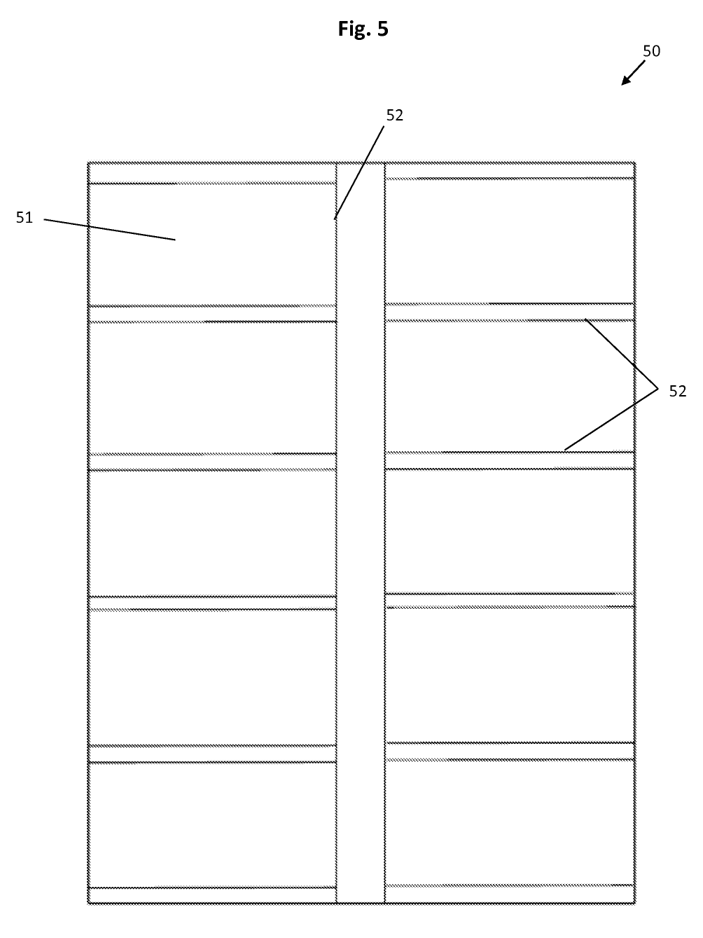

FIG. 5 illustrates an embodiment of at least one business card section 50 of a medical care planner 300 of the present invention. The at least one business card section 50 provides a structure for retaining and holding one or more business cards provided by healthcare professionals, insurance agents, and the like that may be acquired during the treatment and caregiving process. A plurality of business card slots 51 may be defined by a plurality of seams 52. The plurality of seams 52 shown in exemplary FIG. 5 define ten business card slots 51 wherein seams 52 may define at least two edges, and most preferably three edges, thereby forming business card slots 52 or “pockets” for retaining each respective business card. Preferably, the business card section 50 is composed of clear material to allow for visual review of the business cards while each card remains retained within it respective business card slot 51.

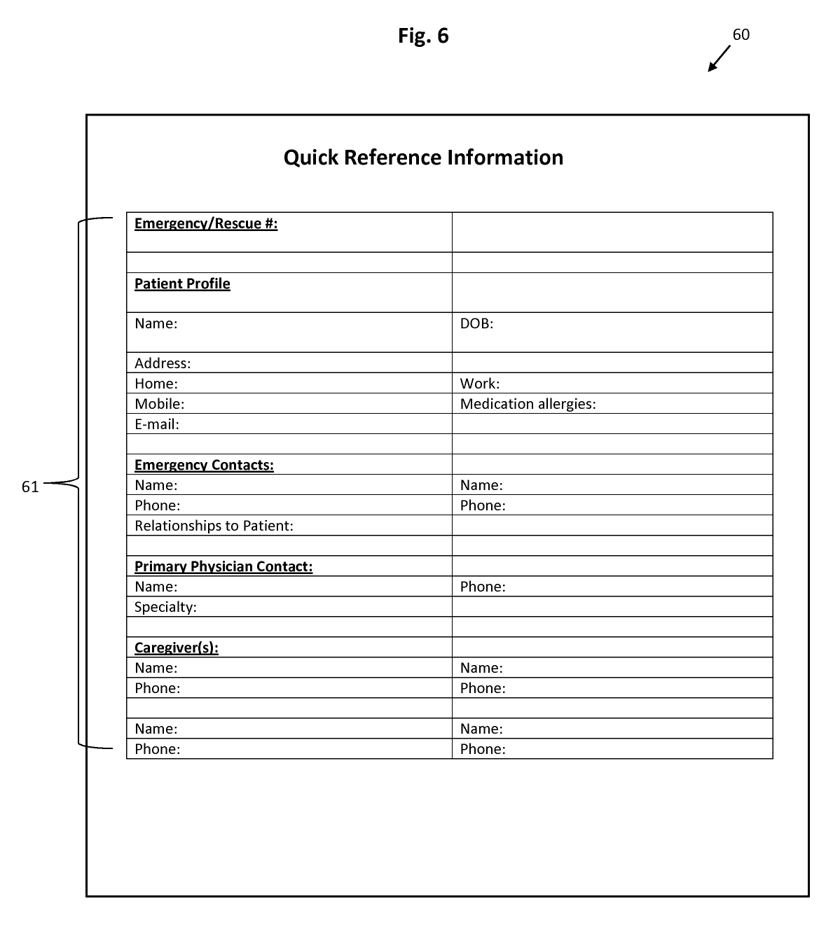

FIG. 6 illustrates an embodiment of at least one quick reference section 60. The quick reference section 60 may provide at least one piece of quick reference information 61. Quick reference information 61 may include but is not limited to emergency rescue telephone numbers; patient profile information including but not limited to patient name, date of birth, mailing address, home telephone number, work telephone number, cellular telephone number, email addresses, medication allergies, social security number, blood type; emergency contact information including but not limited to each emergency contact's name, home telephone number, work telephone number, cellular telephone number, and relationship to the patient; primary physician contact information including but not limited to physician name, work telephone number, and practice area specialty; and caregiver information including but not limited to caregiver name, work telephone number, and cellular telephone number; and the like.

The quick reference section 60 provides a one-stop location for the vast majority of patient and patient-related information that may be needed at a moment's notice by the patient, caregiver, healthcare professional, or emergency responder. While additional and more detailed information may be available under other section headings 41 and sub-section headings 42, the most frequently used information or the information most necessary in an emergency may be provided and accessible within the quick reference section 60.

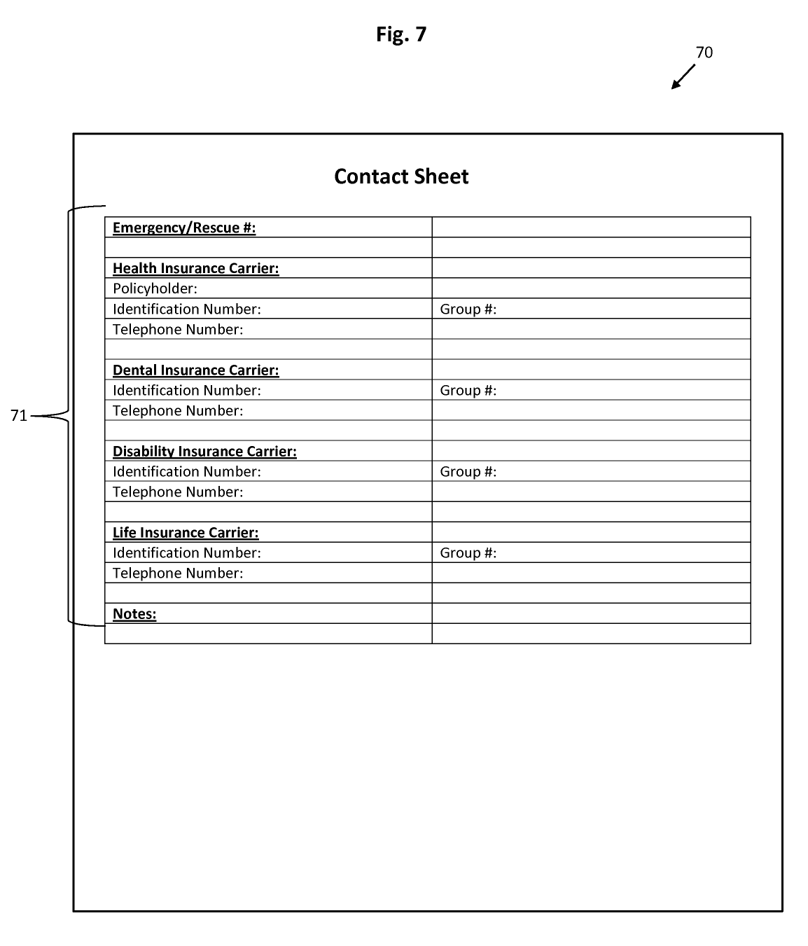

FIG. 7 illustrates an embodiment of at least one insurance contact section 70. The insurance contact section 70 may provide at least one piece of insurance contact information 71. Insurance contact information 71 may include but is not limited to emergency rescue telephone numbers; health insurance carrier information including but not limited to provider name, policyholder name, identification number, group number, and health insurance carrier telephone number; dental insurance carrier information including but not limited to provider name, policyholder name, identification number, group number, and dental insurance carrier telephone number; disability insurance carrier information including but not limited to provider name, policyholder name, identification number, group number, and disability insurance carrier telephone number; life insurance carrier information including but not limited to provider name, policyholder name, identification number, group number, and life insurance carrier telephone number; a notes section; and the like.

The insurance contact section 70 provides a centralized location for pertinent insurance carrier information. In instances such as when insurance coverage needs to be verified, a patient payment reimbursement requested, and the like, the patient or caregiver may refer to the insurance contact section 70 to easily and readily ascertain the patient's specific coverage information or at least find insurance carrier contact information to inquire further the issue or actions needed.

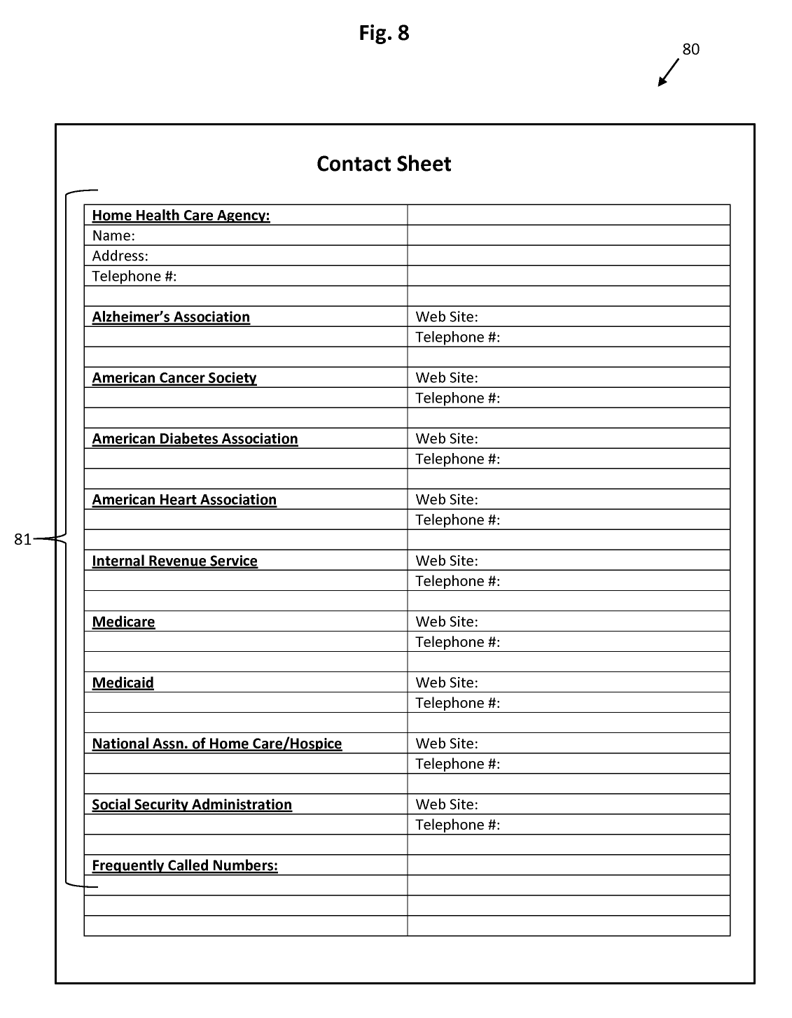

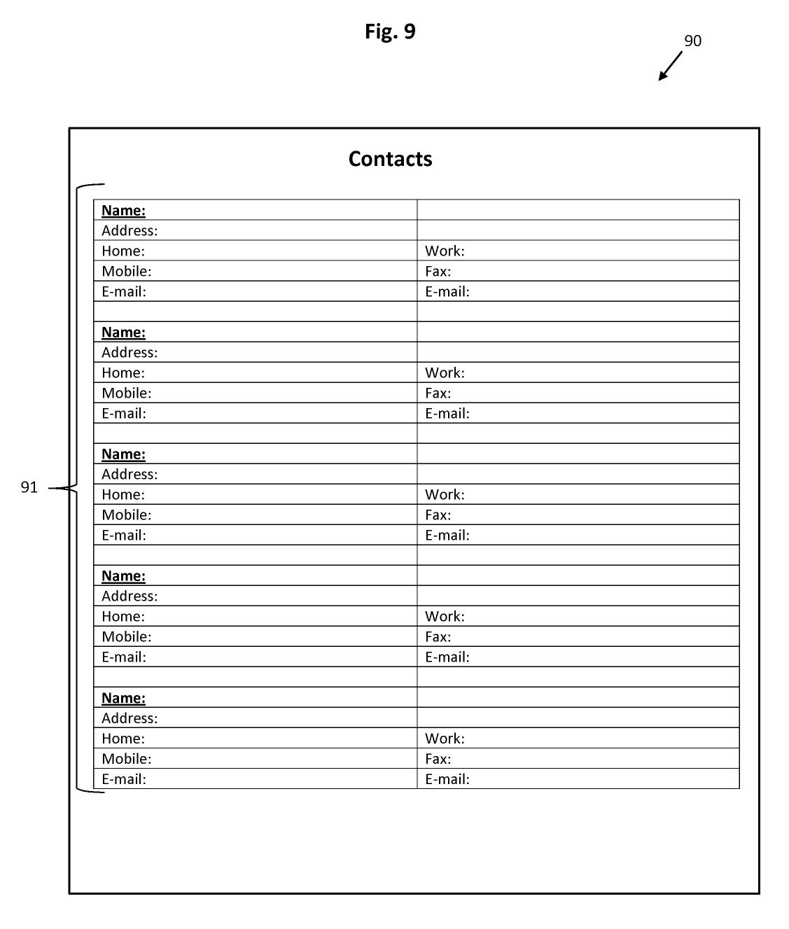

FIG. 8 illustrates an embodiment of at least one common contact section 80. The common contact section 80 may provide at least one piece of common contact information 81. Common contact information 81 may include but is not limited to home health care agency information including but not limited to agency name, mailing address, and telephone number; diagnosis-related association information including but not limited to association web site, mailing address, and telephone numbers; federal or state medical benefits provider information and federal agency information may include but is not limited to agency name, mailing address, and telephone number; frequently called telephone numbers; and the like.

The common contact section 80 may provide a grouping of relevant information 81 that may pertain to a variety of topics and/or providers. Home health care agency information may include but is not limited to individual home care agency information and association information such as the National Association of Home Care and Hospice. Diagnosis-related association information may include but is not limited to entities such as the American Cancer Society, the American Heart Association, the Alzheimer's Association, the American Diabetes Association, the American Lung Association, and the like. Federal or state medical benefits provider information and federal agency information may include but are not limited Medicare, Medicaid, the Social Security Administration, the Internal Revenue Service, and the like.

FIG. 9 illustrates an embodiment of at least one personal contact section 90. The personal contact section 90 may provide at least one piece of personal contact information 91. Personal contact information 91 may include but is not limited to a contact's name, mailing addresses, home telephone number, work telephone number, cellular telephone number, email address, and the like. The personal contact section 90 may be used to record personal contacts such as friends, family, co-workers, human resource representatives, and the like that may or may not fit under a different section heading 41 within the medical care planner 300 of the present invention.

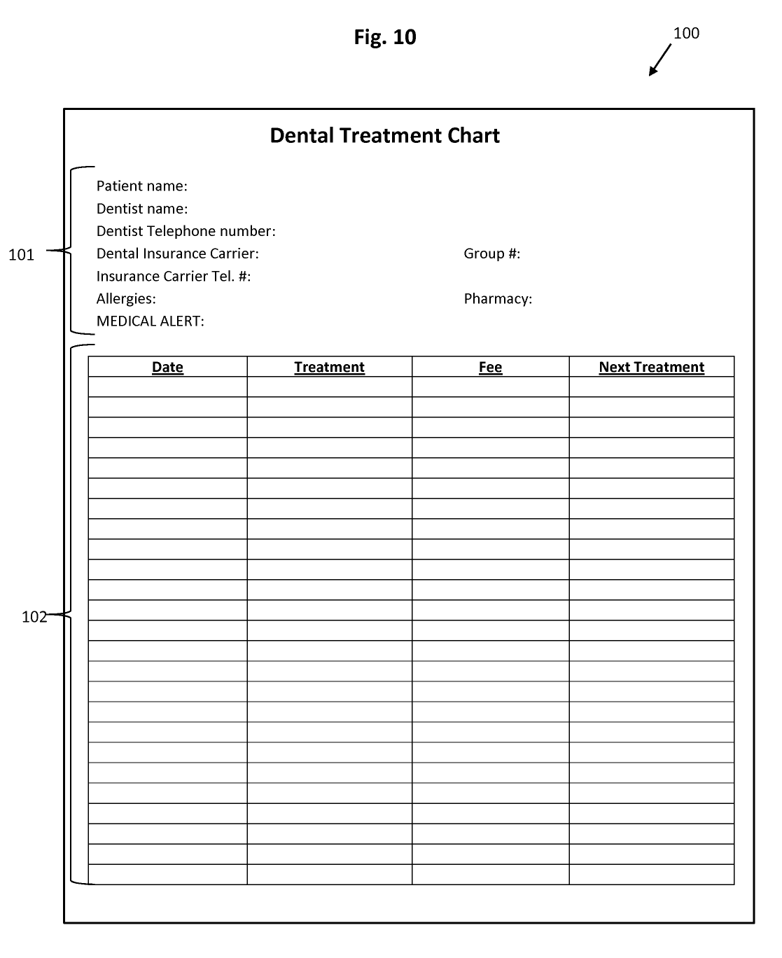

FIG. 10 illustrates an embodiment of at least one dental treatment section 100. The dental treatment section 100 may provide at least one piece of dental treatment information 101 and one or more pieces of dental care information 102. Dental treatment information 101 may include but is not limited to the patient's name, dentist's name, dentist's telephone number, dental insurance carrier name, dental insurance group number, dental insurance telephone number, allergies and other medical alerts, pharmacy information, and the like. Dental care information 102 may include but is not limited to date of treatment, treatment performed, fees due, next treatment/appointment information, and the like.

The dental treatment section 100 allows for a one glance review of the patient's dental history, treatments, costs, and follow-up appointments. In this fashion, a patient or caregiver can easily see previous treatments, next appropriate dates for six month or annual cleanings, and the like.

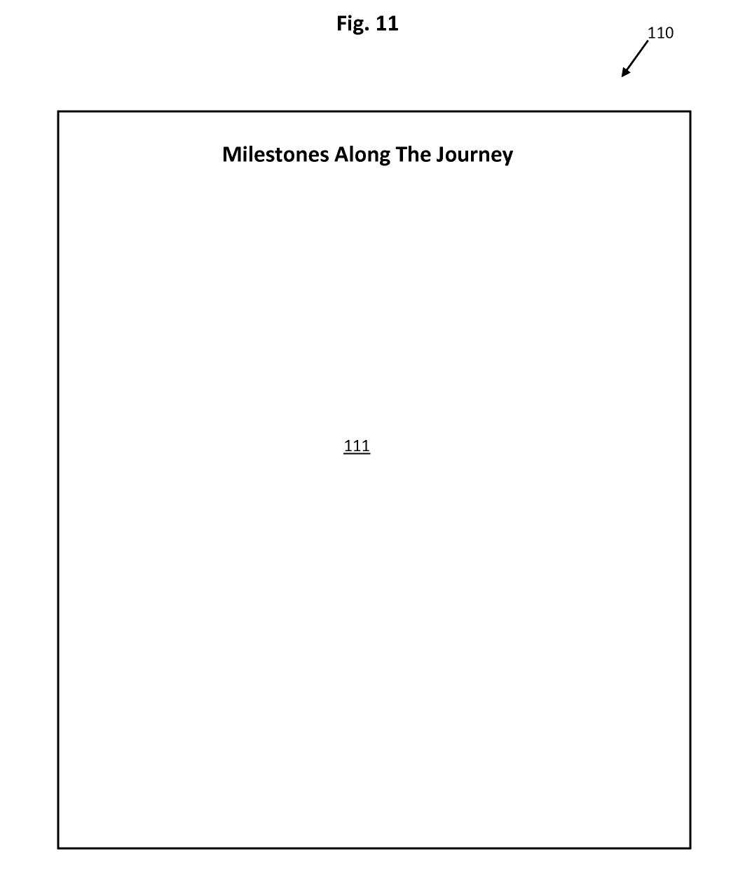

FIG. 11 illustrates an embodiment of at least one milestone information section 110. The milestone information section 110 may provide at least one empty milestone field 111. The milestone field 111 may be used to capture and document milestone information including but not limited to any positive moments in the patient's life, goals reached, treatments completed, family celebrations attended, and the like. Having a written reminder of encouraging moments and even little victories can be an invaluable asset in helping a patient and/or caregiver in dealing with, staying on, and getting through treatments and procedures.

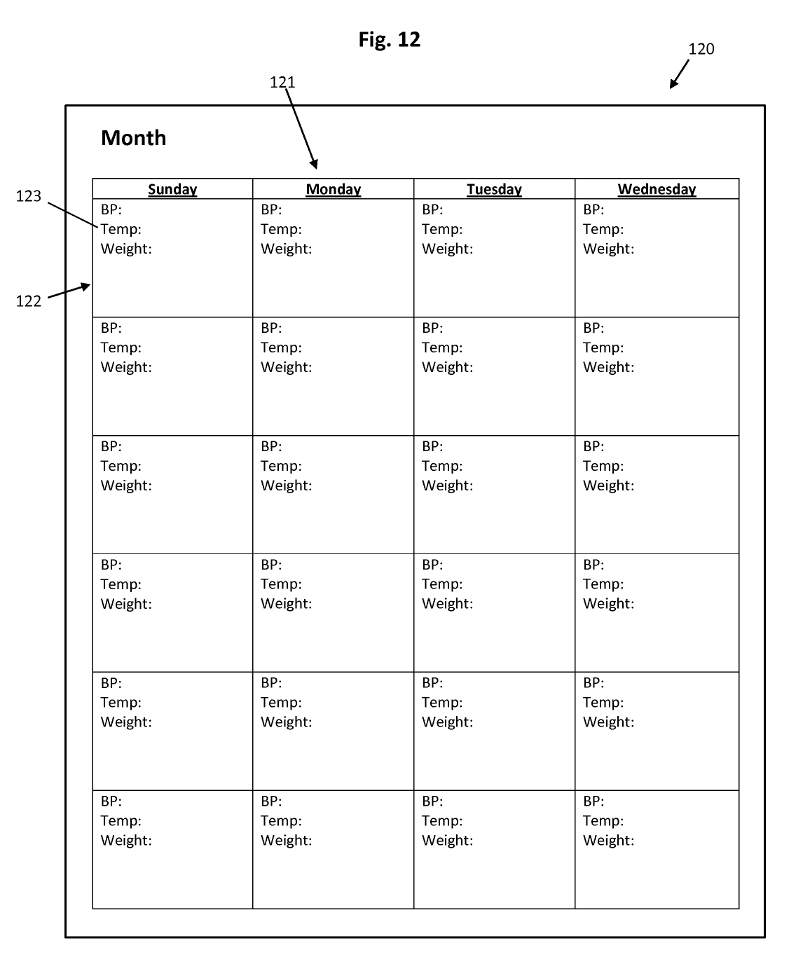

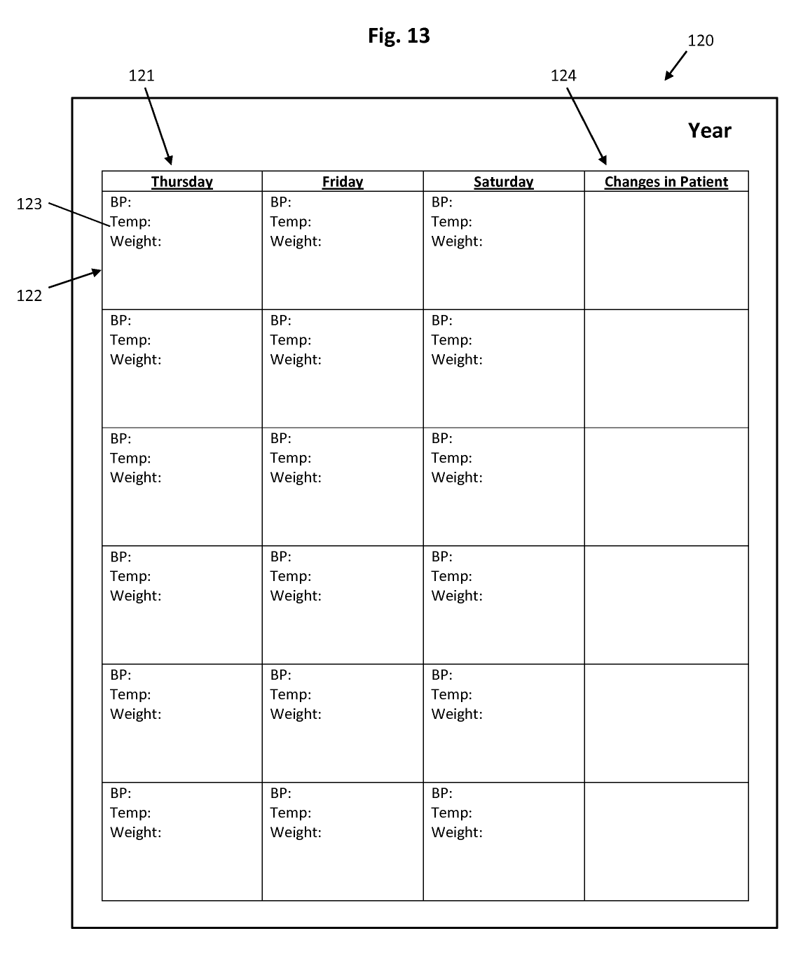

FIGS. 12-13 illustrate an embodiment of at least one undated calendar section 120. The undated calendar section 120 may comprise daily columns 121 and weekly rows 122 along with daily patient information 123. Daily patient information 123 may include but is not limited to patient blood pressure, patient body temperature, patient body weight, and any other measurements or readings that are known to be either relevant or pertinent to a diagnosed ailment or for generally monitoring patient health. Having a ‘changes in patient’ field 124 may allow for the observation and recording of trends or deviations found within the daily patient information 123 to potentially alert the patient and/or caregiver to beneficial or harmful changes that may be a result of the diagnosed illness or an associated treatment.

Most relevant for home care patients, the monitoring of simple to record bodily data such as the daily patient information 123 listed above may trigger a warning that further medical attention may be required or show evidence that certain treatments are working if anticipated positive trends are realized. Trends or shifts in daily patient information 123 may be summarized and compared on a day-to-day basis, a weekly basis, a monthly basis, or any recurring interval as deemed appropriate. In a preferred embodiment, the changes in patient field 124 shown in FIG. 13 illustrates a weekly changes in patient summary field 124 that may be used to note and record the fluctuations within the daily patient information 123 over a weekly time period on the undated calendar section 120.

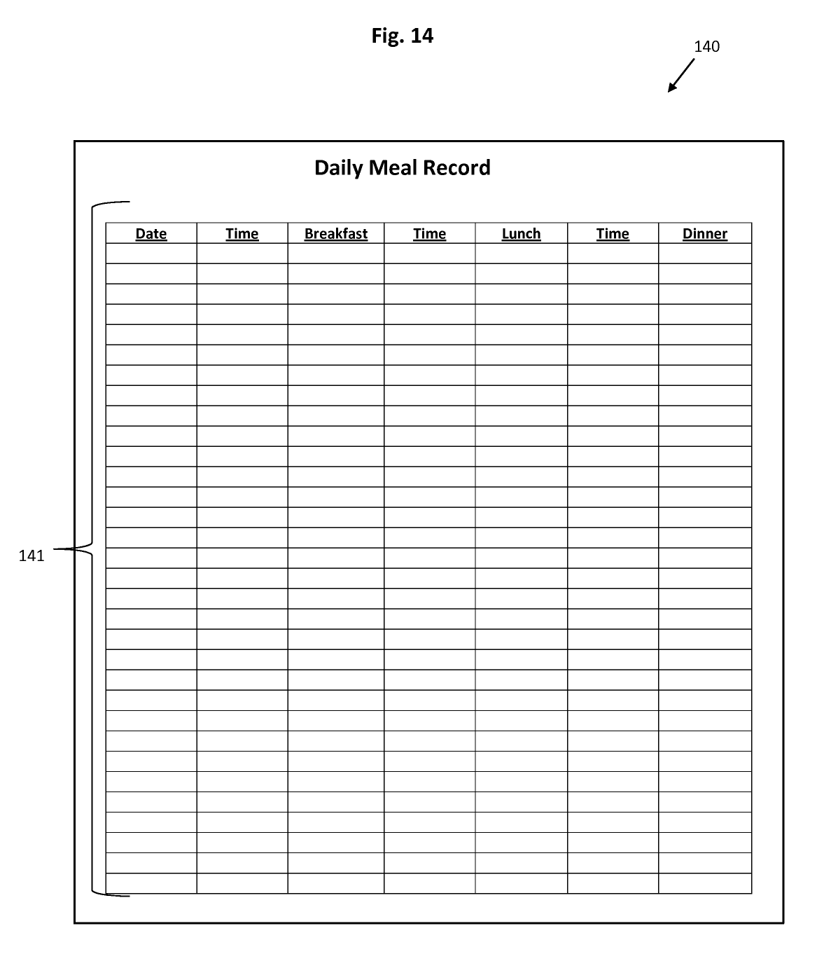

FIG. 14 illustrates an embodiment of at least one daily meal record section 140. The daily meal record section 140 may provide at least one piece of daily meal record information 141. Daily meal record information 141 may include but is not limited to date, time of breakfast, description of breakfast, time of lunch, description of lunch, time of dinner, description of dinner, and the like.

The daily meal record section 140 allows the patient, caregiver, or healthcare professionals to track and monitor the time and meal description for each meal consumed by the patient. In this way, healthcare professionals such as doctors or dieticians may review a thorough record of the patient's eating and dietary habits. The patient's eating and dietary habits may also be compared to the daily patient information 123, as shown in FIG. 12, to see if any of the patient's eating habits may have contributed to any potential trends found within the daily patient information 123. Additional meal record information 141 may also be gathered to further supplement the meal record information 141 described above. Calorie count information, grams of carbohydrates, grams of fats, grams of proteins, and the like may be closely monitored if it may assist in the patient's treatment process.

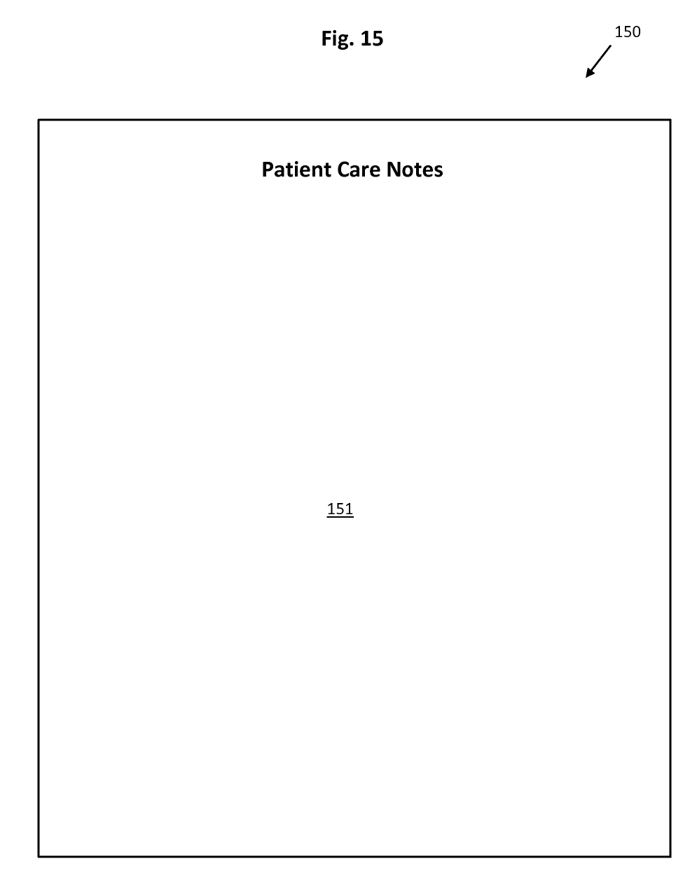

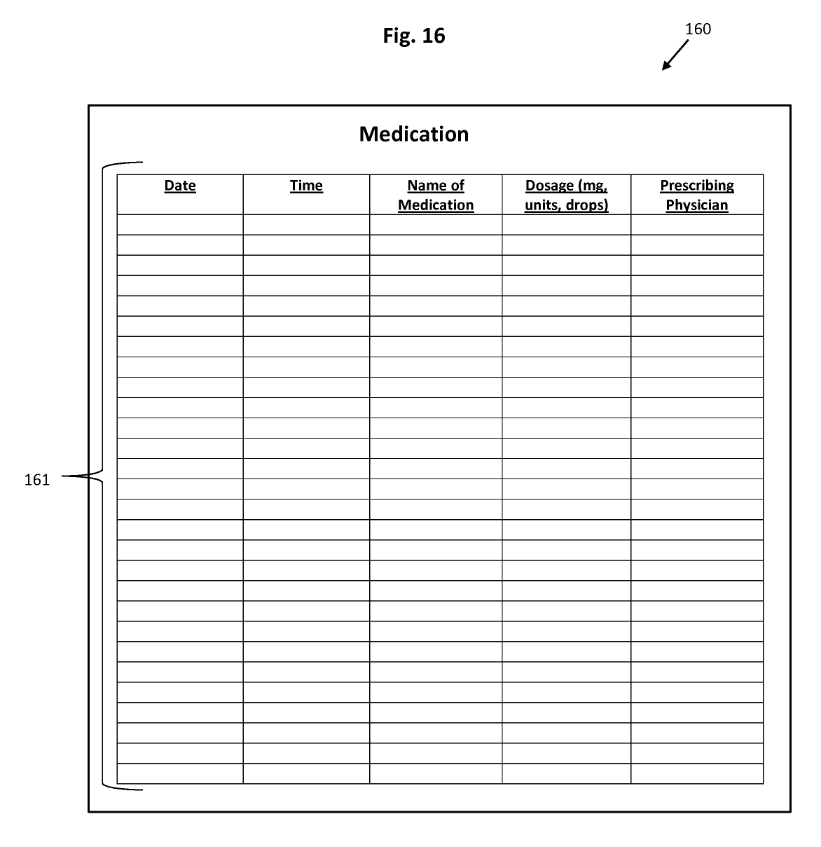

FIG. 15 illustrates an embodiment of at least one patient care notes section 150. The patient care notes section 150 may provide at least one empty patient care notes field 151. The patient care notes field 151 may be used to capture and record any patient care information that is relevant to the patient's medical care and/or home care. Any notations such as patient preferences, moods, reactions to treatments, and the like may be recorded within the patient care notes field 151 as needed.

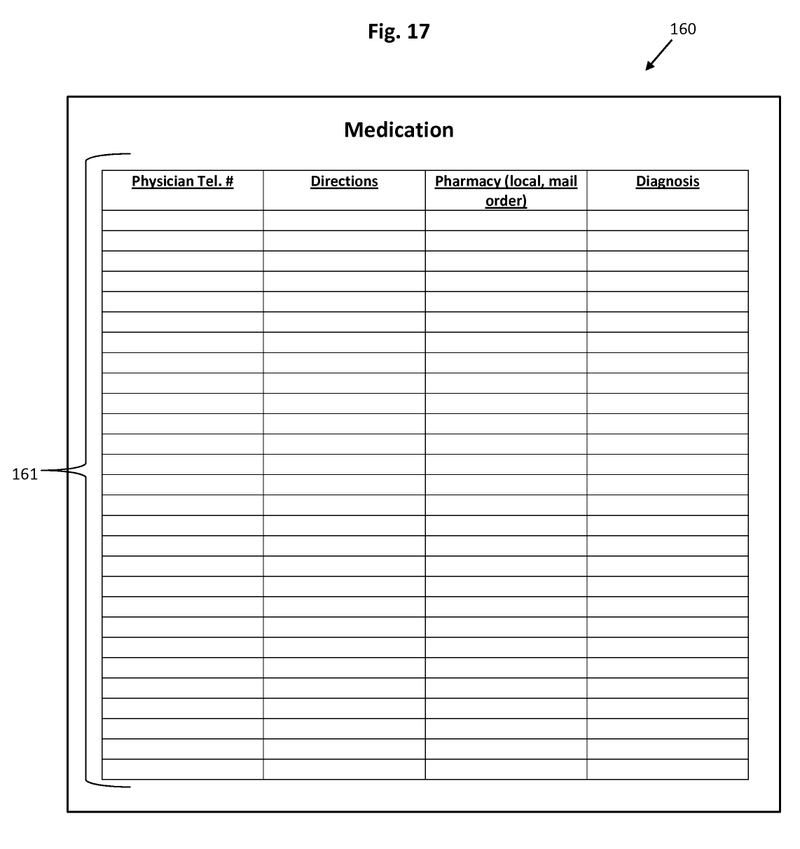

FIGS. 16-17 illustrate an embodiment of at least one medicinal log section 160. The medicinal log section 160 may provide at least one piece of medicinal log information 1611. Medicinal log information 161 may include but is not limited to date, time of dose, name of medication, dosage amount, prescribing physician name, physician telephone number, directions for taking medication, pharmacy contact information, diagnosis requiring medication, and the like.

The medicinal log section 160 may be very useful to the patient, caregiver, or healthcare professionals to monitor the medications being taken by the patient and logging dosages taken so that one or more dosage times are not missed or duplicated due to simple forgetfulness or disorganization. Thus whether multiple care providers share duties in a home setting or the patient is continually moved between home care and hospital care, the medical care planner 300 of the present invention may easily be brought with the patient to allow any care providers to easily see the current medications being taken and each and every dosage that was taken to eliminate the chance or either over medicating or under medicating the patient accidentally. Additionally, doctor and pharmacy information may also be available in the medicinal log section 160 to allow for a quick reference if any questions or issues arise regarding a specific medication that is logged and documented within the planner 300.

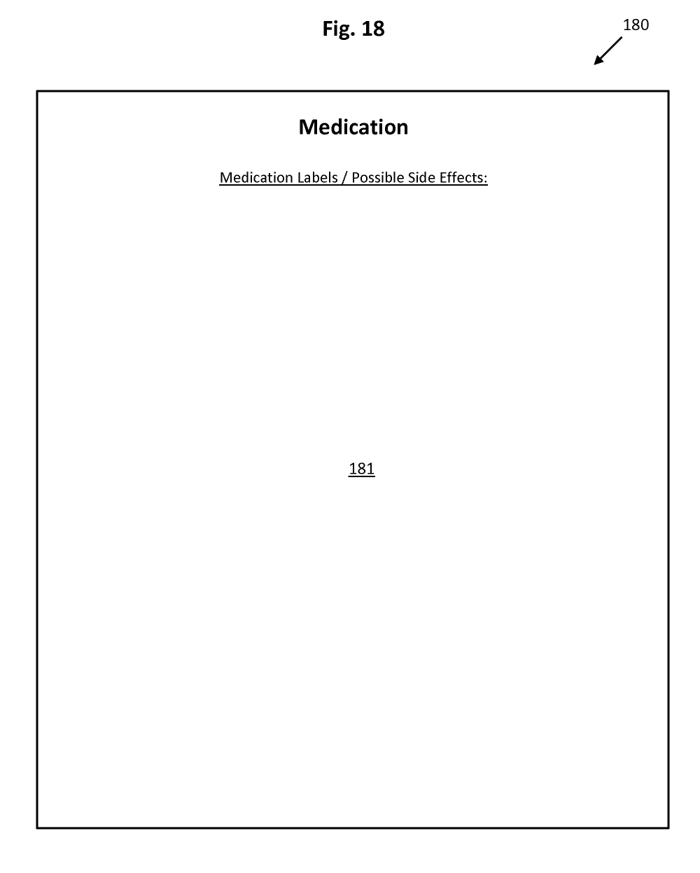

FIG. 18 illustrates an embodiment of at least one medication information section 180. The medication information section 180 may provide at least one empty medication information field 181. The medication information field 181 may be used to record and document medication information in one convenient location. Examples of medication information may include but are not limited to medicinal label information, potential side effects, dosage instructions, generic alternatives, contraindication information, experimental drug options, and the like.

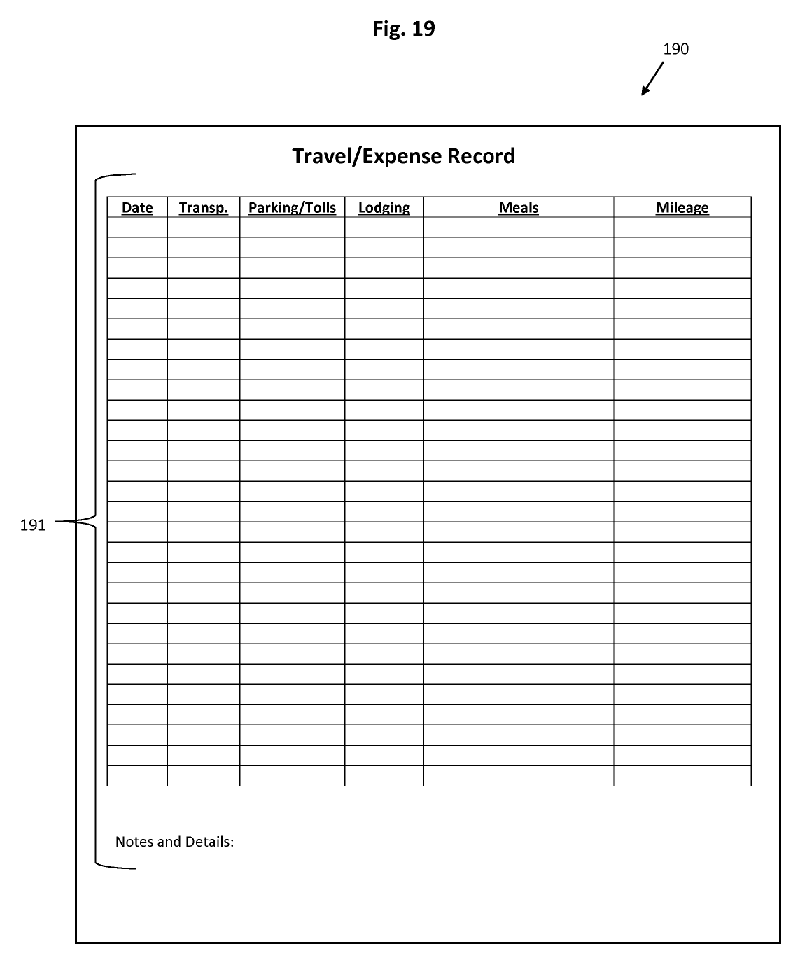

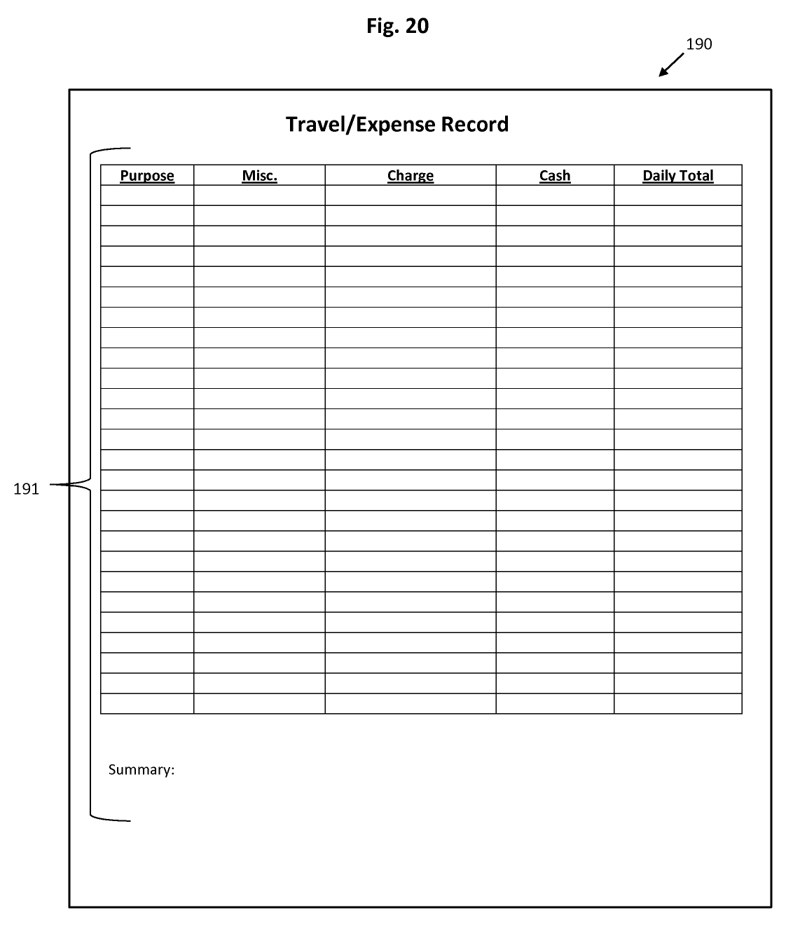

FIGS. 19-20 illustrate embodiments of one or more travel and expense record sections 190. Each travel and expense record section 190 may provide at least one piece of travel and expense record information 191. Travel and expense record information 191 may include but is not limited to date(s) of travel, transportation, parking and tolls, lodging, meals, mileage, general purpose, miscellaneous, charges, cash, daily totals, a notes and details section, a summary section, and the like.

The travel and expense record section 190 may provide any number of travel and expense record information 191 categories as listed above allowing for recording and documenting all expenses incurred that may be relevant to any insurance carrier, any reimbursement items, and tax deductible items, travel expenses, and the like. The travel and expense record section 190 may provide a general accounting record of any costs or expenses related the patient's care and treatment.

The medical care planner 300 may be used as a life saving device in an emergency situation to provide emergency personnel with required information. The planner 300 may also be used both during doctor visits, hospital stays, and home care to eliminate mistakes and on a daily basis to manage the individual's taking of medications, meals, daily patient information, milestones, and the like.

It will be appreciated that the size, number, or manner of gathering information in each section 41 or sub-section 42 of the medical care planner 300 may be varied as needed in order to adequately display an individual patient's information.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. A medical care planner for organizing and recording patient information, comprising:
a cover having a front portion and a back portion;
a plurality of pages disposed between said front portion and said back portion of said cover; and
a binding in communication with said cover and said plurality of pages for maintaining said medical care planner in a bound configuration.

2. The medical care planner of claim 1, further comprising:
at least one pocket folder.

3. The medical care planner article of claim 1, further comprising:
at least one envelope capable of holding a plurality of loose items.

4. The medical care planner article of claim 1, wherein said plurality of pages further comprises:
at least one business card section capable of retaining one or more business cards.

5. The medical care planner article of claim 4, wherein said at least one business card section comprises:
a plurality of seams defining a plurality of business card slots for retaining said one or more business cards.

6. The medical care planner article of claim 1, wherein said plurality of pages further comprises:
at least one quick reference section comprising at least one piece of quick reference information selected from the group consisting of emergency rescue information, patient information, emergency contact information, primary physician information, and caregiver information.

7. The medical care planner article of claim 1, wherein said plurality of pages further comprises:
at least one insurance contact section comprising at least one piece of insurance contact information selected from the group consisting of emergency rescue information, health insurance carrier information, dental insurance carrier information, disability insurance carrier information, and life insurance carrier information.

8. The medical care planner article of claim 1, wherein said plurality of pages further comprises:
at least one common contact section comprising at least one piece of common contact information selected from the group consisting of home health care agency information, medical benefit provider information, federal agency information, and diagnosis-related association information.

9. The medical care planner article of claim 1, wherein said plurality of pages further comprises:
at least one dental treatment section comprising at least one piece of dental treatment information selected from the group consisting of dental care provider information, dental insurance carrier information, and dental care information.

10. The medical care planner article of claim 1, wherein said plurality of pages further comprises:
at least one milestone information section comprising at least one empty milestone field for entry of milestone information.

11. The medical care planner article of claim 1, wherein said plurality of pages further comprises:
at least one undated calendar section comprising at least one piece of daily patient information selected from the group consisting of patient blood pressure, patient body temperature, and patient body weight.

12. The medical care planner article of claim 11, wherein said at least one undated calendar section further comprises:
a changes in patient field for receiving observed changes in said at least one piece of daily patient information.

13. The medical care planner article of claim 1, wherein said plurality of pages further comprises:
at least one daily meal record section comprising at least one piece of daily meal information selected from the group consisting of date, time of meal, description of breakfast, description of lunch, and description of dinner.

14. The medical care planner article of claim 1, wherein said plurality of pages further comprises:
at least one patient care notes section comprising at least one empty patient care notes field for entry of patient care information.

15. The medical care planner article of claim 1, wherein said plurality of pages further comprises:
at least one medication log section comprising at least one piece of medication log information selected from the group consisting of date, time of dosage, name of medication, dosage, prescribing physician, physician telephone number, medication directions, pharmacy information, and diagnosis information.

16. The medical care planner article of claim 1, wherein said plurality of pages further comprises:
at least one medication section comprising at least one empty medication information field for entry of medication label information and side effects.

17. The medical care planner article of claim 1, wherein said plurality of pages further comprises:
at least one travel and expense record section comprising at least one piece of travel and expense record information selected from the group consisting of date, transportation method, parking and tolls, lodging, meals, mileage, purpose, miscellaneous, charges, cash, and daily total.

18. A medical care planner for organizing and recording patient information, comprising:
a cover having a front portion and a back portion;
a plurality of pages disposed between said front portion and said back portion of said cover, wherein said plurality of pages further comprises:
at least one business card section capable of retaining one or more business cards, wherein said business card section comprises a plurality of seams defining a plurality of business card slots for retaining said one or more business cards;
at least one quick reference section comprising at least one piece of quick reference information selected from the group consisting of emergency rescue information, patient information, emergency contact information, primary physician information, and caregiver information;
at least one insurance contact section comprising at least one piece of insurance contact information selected from the group consisting of emergency rescue information, health insurance carrier information, dental insurance carrier information, disability insurance carrier information, and life insurance carrier information;
at least one common contact section comprising at least one piece of common contact information selected from the group consisting of home health care agency information, medical benefit provider information, federal agency information, and diagnosis-related association information;
at least one dental treatment section comprising at least one piece of dental treatment information selected from the group consisting of dental care provider information, dental insurance carrier information, and dental care information;
at least one milestone information section comprising at least one empty milestone field for entry of milestone information;
at least one undated calendar section comprising at least one piece of daily patient information selected from the group consisting of patient blood pressure, patient body temperature, and patient body weight, wherein said at least one undated calendar section further comprises a changes in patient field capable of receiving observed changes in at least one measurement selected from the group consisting of said patient blood pressure, said patient body temperature, and said patient body weight;
at least one daily meal record section comprising at least one piece of daily meal information selected from the group consisting of date, time of meal, description of breakfast, description of lunch, and description of dinner;
at least one patient care notes section comprising at least one empty patient care notes field for entry of patient care information;
at least one medication log section comprising at least one piece of medication log information selected from the group consisting of date, time of dosage, name of medication, dosage, prescribing physician, physician telephone number, medication directions, pharmacy information, and diagnosis information;
at least one medication information section comprising at least one open medication information field for entry of medication label information and side effects;
at least one travel and expense record section comprising at least one piece of travel and expense record information selected from the group consisting of date, transportation method, parking and tolls, lodging, meals, mileage, purpose, miscellaneous, charges, cash, and daily total; and
a binding in communication with said cover and said plurality of pages for maintaining said medical care planner in a bound configuration.

19. The medical care planner of claim 18, further comprising:
at least one pocket folder.

20. The medical care planner article of claim 1, further comprising:
at least one envelope capable of holding a plurality of loose items.
